(19) United States
(12) Patent Application Publication
(10) Pub. No.: US 2018/0034992 A1
(43) Pub. Date: Feb. 1, 2018

(54) IMAGE READING DEVICE AND IMAGE FORMING APPARATUS

(71) Applicant: KYOCERA Document Solutions Inc., Osaka (JP)

(72) Inventor: Izumi KADOBAYASHI, Osaka (JP)

(73) Assignee: KYOCERA Document Solutions Inc., Osaka (JP)

(21) Appl. No.: 15/656,543

(22) Filed: Jul. 21, 2017

(30) Foreign Application Priority Data
Jul. 29, 2016 (JP) 2016-150674

(51) Int. Cl. H04N 1/00

(52) U.S. Cl. CPC H04N 1/00824; H04N 1/00037; H04N 1/0005; H04N 1/00063; H04N 1/00076; H04N 2201/0094

(57) ABSTRACT

An image reading device includes: contact glass, a document reading section that reads a document loaded on the contact glass while a moving mechanism moves in a document reading direction, a reading control section that causes the document reading section to read the whole contact glass at a rate of once per a predefined number of times N1, a first contamination detection section, and a report section. The first contamination detection section detects, from image data of the whole contact glass obtained through the reading by the document reading section, contamination of the contact glass present in a region other than a region loaded with the document. The report section, upon detecting by the first contamination detection section the same contamination from all the pieces of image data obtained consecutively a predefined plural number of times M1, reports a user that the contamination is present on the contact glass.

### INCORPORATION BY REFERENCE

This application claims priority to Japanese Patent Application No. 2016-150674 filed on 29 Jul. 2016, the entire contents of which are incorporated by reference herein.

### BACKGROUND

This disclosure relates to an image reading device and an image forming apparatus, and more specifically to an image reading device having contact glass for loading a document thereon and an image forming apparatus including this image reading device.

Some image forming apparatus such as copiers perform: document-loaded reading in which a document reading section loaded with a scanner reads a document loaded onto document-loaded reading contact glass by a user's hand while moving with respect to the document; and document-conveyed reading in which a document conveyed by an automatic document delivery device and passing through document-conveyed reading contact glass is read by the scanner.

The image forming apparatus prints an image of the document onto a recording medium based on image data obtained through the reading by the scanner. Through use of the image forming apparatus, the contact glass is contaminated with dust, a foreign substance, etc. As a result of the contamination of the contact glass, the contamination is reflected on printing, leading to printing quality deterioration. Thus, to prevent the printing quality deterioration, various inventions for detecting contamination of contact glass have been suggested.

### SUMMARY

As one aspect of this disclosure, a technology obtained by further improving the technology described above will be suggested.

An image reading device according to one aspect of this disclosure includes: contact glass, a document reading section, a reading control section, a first contamination detection section, and a report section. The contact glass loads a document thereon. The document reading section has a moving mechanism capable of reciprocally moving in a predefined document reading direction, and reads the document loaded on the contact glass while the moving mechanism moves in the document reading direction. The reading control section, to cause the document reading section to read the document loaded on the contact glass, causes the document reading section to read the whole contact glass at a rate of once per a predefined number of times N1. The first contamination detection section detects, from image data of the whole contact glass obtained through the reading by the document reading section, contamination of the contact glass present in a region other than a region loaded with the document. The report section, upon detecting by the first contamination detection section the same contamination from all the pieces of image data obtained consecutively a predefined plural number of times M1, reports to a user that the contamination is present on the contact glass.

An image forming apparatus according to another aspect of this disclosure includes: the image reading device described above; and an image formation section performing image formation on a recording medium based on the image data of the document obtained through the reading by the image reading device.

### BRIEF DESCRIPTION OF THE DRAWINGS

FIG. 1 is a perspective view illustrating outer appearance of an image forming apparatus according to a first embodiment of this disclosure.

FIG. 2 is a functional block diagram roughly illustrating main inner configuration of the image forming apparatus according to the first embodiment.

FIG. 3 is a transmission plan view schematically illustrating inner configuration of a document reading section.

FIG. 4 is a diagram illustrating one example of a display screen displayed at a display section.

FIG. 5 is a flowchart illustrating one example of processing operation performed at a control unit.

FIG. 6 is a flowchart illustrating one example of the processing operation performed at the control unit.

FIGS. 7A to 7C are diagrams schematically illustrating examples of images indicated by image data obtained consecutively three times in the past, where FIG. 7A is the image indicated by the latest image data, FIG. 7B is the image indicated by the last image data, and FIG. 7C is the image indicated by the second last image data.

FIG. 8 is a diagram illustrating one example of a display screen displayed at the display section.

### DETAILED DESCRIPTION

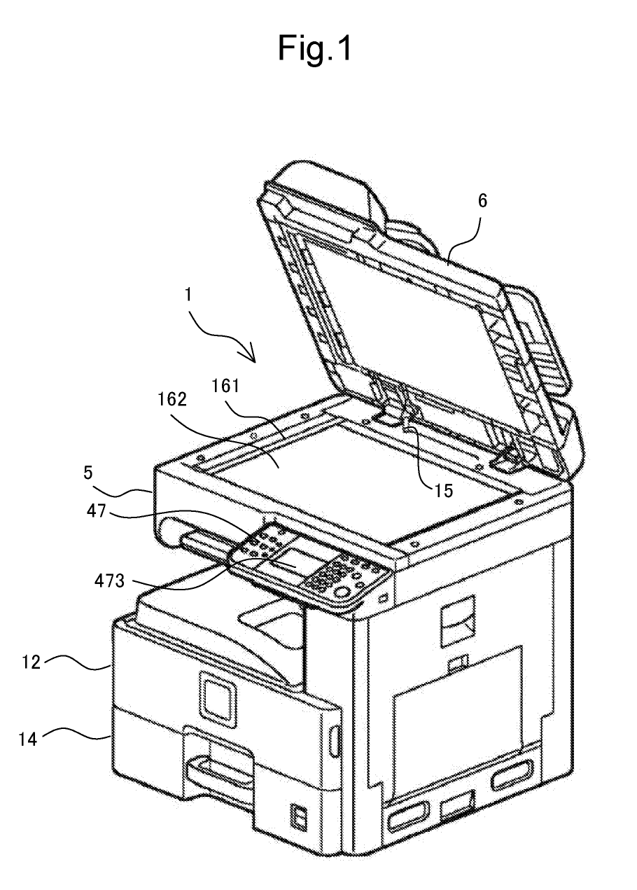

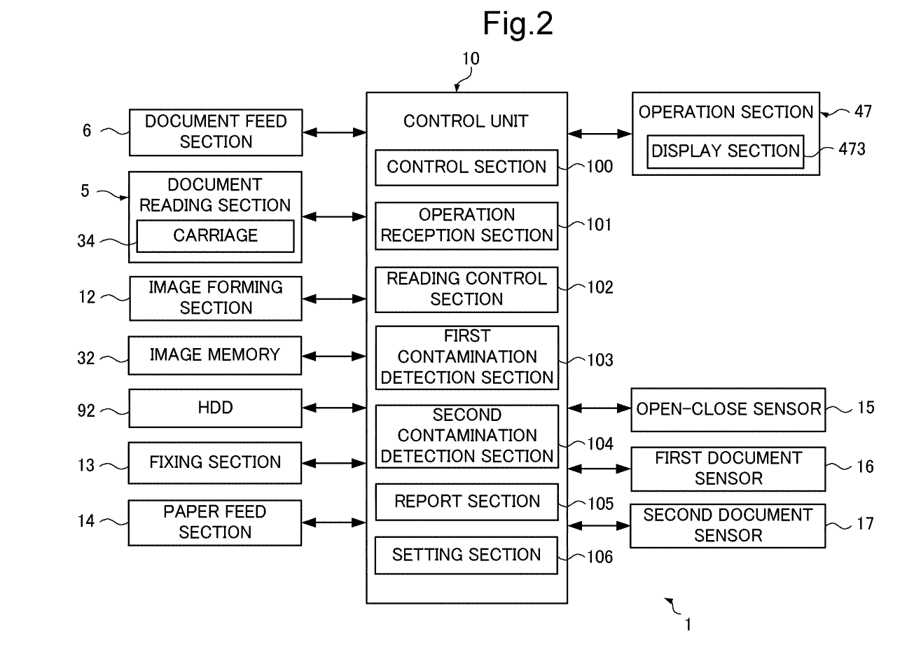

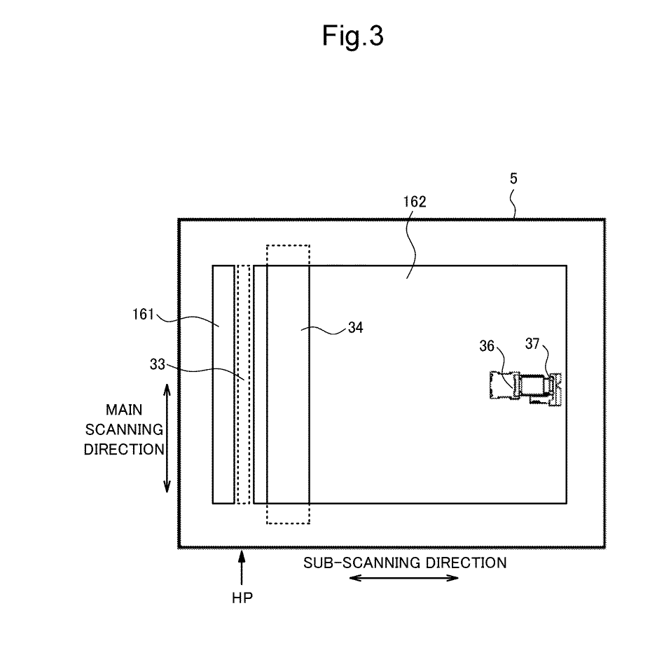

Hereinafter, an image reading device and an image forming apparatus according to one embodiment of this disclosure will be described with reference to the drawings. FIG. 1 is a perspective view illustrating outer appearance of the image forming apparatus according to the first embodiment of this disclosure. FIG. 2 is a functional block diagram roughly illustrating main inner configuration of the image forming apparatus according to the first embodiment. FIG. 3 is a transmission plan view schematically illustrating inner configuration of a document reading section.

The image forming apparatus 1 is a multifunction peripheral combining together a plurality of functions such as, for example, a copy function, a printer function, a scanner function, and a facsimile function, and includes: a control unit 10, a document feed section 6, a document reading section 5, an image formation section 12, an image memory 32, a hard disk drive (HDD) 92, a fixing section 13, a paper feed section 14, an operation section 47, an open-close sensor 15, a first document sensor 16, and a second document sensor 17.

The document reading section 5 irradiates a document by using a light irradiation section and receives light reflected thereon to thereby read an image from the document. The document reading section 5 includes: document-conveyed reading contact glass 161, document-loaded reading contact glass 162, a white reference plate 33, a carriage 34, a condensing lens 36, and a charge coupled device (CCD) sensor 37. Note that the document-loaded reading contact glass 162 is one example of contact glass in the scope of the claims.

The white reference plate 33 is a white plate provided between the document-conveyed reading contact glass 161 and the document-loaded reading contact glass 162 along a main scanning direction. The white reference plate 33 is used for shading correction. Image data read from the white reference plate 33 is used as white reference data.

The carriage 34 includes: a light source (not illustrated) such as a light emitting diode (LED); and a plurality of mirrors (not illustrated) which reflects read light reflected on the document towards the CCD sensor 37. The document reading section 5 also includes, for example, a driving motor (not illustrated) formed of a step motor. The carriage 34 is provided in a manner such as to be capable of reciprocally moving in a sub-scanning direction (a document reading direction in this embodiment) as a moving mechanism under control performed by, for example, the control section 100 by a driving force provided from the driving motor.

The document feed section 6 feeds a document to be read to the document reading section 5. Moreover, the document feed section 6 is formed in a manner such as to be capable of opening and closing with respect to a top surface of the document reading section 5 by, for example, a hinge. The document feed section 6 functions as a document press cover upon reading the document loaded on the document-loaded reading contact glass 162 of the document reading section 5.

The image formation section 12 forms, on paper (recording medium), a toner image of an image to be printed. The image memory 32 is a region provided for temporarily storing image data of the document obtained through the reading by the document reading section 5 and temporarily saving data to be printed at the image formation section 12.

The HDD 92 is a large-capacity storage device which stores, for example, the document image read by the document reading section 5. The fixing section 13 fixes, on the paper through thermal compression, the toner image formed thereon. The paper feed section 14 picks up and conveys paper stored in a paper feed cassette.

The open-close sensor 15 detects whether the document feed section 6 is in an open state or in a closed state as the document press cover, and outputs a detection signal to the control unit 10. The first document sensor 16 detects presence or absence of the document set at the document feed section 6, and outputs a detection signal to the control unit 10. The second document sensor 17 includes a plurality of light sensors (not illustrated) which is provided below the document-loaded reading contact glass 162 in correspondence with document sizes, detects the presence or absence of the document loaded on the document-loaded reading contact glass 162 and then the document size, and outputs a detection signal to the control unit 10.

The operation section 47 receives, from an operator, instructions such as an image formation operation execution instruction, a document reading operation execution instruction, etc. for various types of operation and processing executable by the image forming apparatus 1. The operation section 47 includes a display section 473 which displays, for example, an operation guide to the operator. The display section 473 is a touch panel, and the operator can touch buttons and keys displayed on a screen to operate the image forming apparatus 1.

The control unit 10 includes: a processor, a random access memory (RAM), a read only memory (ROM), and a dedicated hardware circuit. The processor is, for example, a central processing unit (CPU), an application specific integrated circuit (ASIC), or a micro-processing unit (MPU). The control unit 10 includes: a control section 100 in charge of overall operation control of the image forming apparatus 1; an operation reception section 101, a reading control section 102, a first contamination detection section 103, a second contamination detection section 104, a report section 105, and a setting section 106.

The control unit 10 functions as the control section 100, the operation reception section 101, the reading control section 102, the first contamination detection section 103, the second contamination detection section 104, the report section 105, and the setting section 106 through operation in accordance with control programs installed in the HDD 92. Note that, however, the control section 100, etc. can each be formed by a hardware circuit without depending on the operation performed by the control unit 10 in accordance with the control programs. Hereinafter, unless otherwise specified, the same applies to each embodiment.

The control section 100 is connected to the document feed section 6, the document reading section 5, the image formation section 12, the image memory 32, the HDD 92, the fixing section 13, the paper feed section 14, the operation section 47, the open-close sensor 15, the first document sensor 16, and the second document sensor 17 to perform driving control of each of these sections.

The operation reception section 101 receives operation from the user.

The reading control section 102 performs, for example, control of causing the document reading section 5 to read the document loaded on the document-loaded reading contact glass 162.

The first contamination detection section 103 detects, from image data of the whole document-loaded reading contact glass 162 obtained through the reading by the document reading section 5, contamination of the document-loaded reading contact glass 162 present in a region other than a region loaded with a document of a predefined size.

For example, the reading control section 102 causes the document reading section 5 to perform document reading operation on the document-loaded reading contact glass 162 present in the region other than the region loaded with the document of the predefined size, and acquires image data obtained though the reading of the region other than the region loaded with the document of the predefined size. The first contamination detection section 103 determines whether or not the acquired image data includes image data indicating an image formed by a predefined number of pixel groups including a pixel value other than a pixel value indicating white. Note that this image is hereinafter referred to as a contaminated image. Here, the pixel value indicating white is, for example, a 256 value, which is, for example, in a range between 240 and 256. Moreover, the predefined number is not specifically limited, but is a number of pixels required for forming an image of such a size which permits user's confirmation with his or her naked eye, for example, 7168 pixels with a resolution of 600DPI×600DPI. The first contamination detection section 103, upon determination that the aforementioned acquired image data includes the image data indicating the aforementioned contaminated image, detects that contamination is present in the region of the document-loaded reading contact glass 162 other than the region loaded with the document of the predefined size.

Note that a desirable document as the document of the predefined size is a document of an A4 size which is most frequently used in business scenes. Thus, the aforementioned predefined size is described as an A4 size in this embodiment.

The second contamination detection section 104 detects the contamination of the document-loaded reading contact glass 162 from the image data of the whole document-loaded reading contact glass 162 loaded with no document which data has been obtained through the reading by the document reading section 5.

For example, the reading control section 102 causes the document reading section 5 to perform the document reading operation on the document-loaded reading contact glass 162 loaded with no document, and thereby acquires the image data of the whole document-loaded reading contact glass 162. The second contamination detection section 104 determines whether or not the aforementioned acquired image data includes the image data indicating the image formed by the predefined number of pixel groups including the pixel value other than the pixel value indicating white. The second contamination detection section 104, upon determination that the aforementioned acquired image data includes the image data indicating the aforementioned contaminated image, detects that contamination is present on the document-loaded reading contact glass 162.

Specifically, the second contamination detection section 104 is capable of detecting the contamination of the document-loaded reading contact glass 162 which cannot be detected in the first contamination detection section 103 and which is present in a region loaded with a document of, for example, an A4 size as the aforementioned predefined size.

The report section 105 notifies the user that the contamination is present on the document-loaded reading contact glass 162.

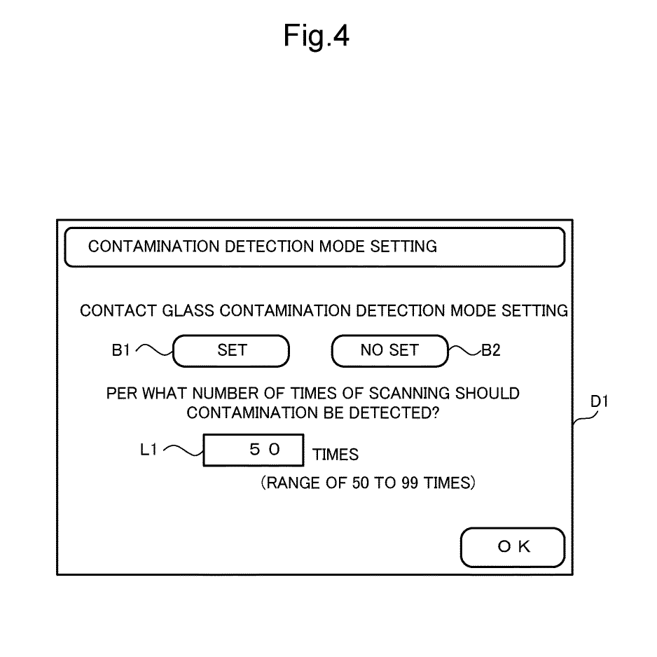

Upon receiving, by the operation reception section 101 from the user, a request for setting to a contamination detection mode in which the contamination of the document-loaded reading contact glass 162 is detected, the setting section 106 sets this contamination detection mode. For example, upon receiving, by the operation reception section 101 from the user, a request for displaying a contamination detection mode setting screen, the setting section 106 displays, at the display section 473 (FIGS. 1 and 2), a “contamination detection mode setting” screen D1, as illustrated in FIG. 4, for detecting the contamination of the document-loaded reading contact glass 162.

Formed on the “contamination detection mode setting” screen D1 are: a selection button B1 on which “SET” for selecting the contamination detection mode setting is written; a selection button B2 on which “NO SET” is written; and an input box L1 for inputting an interval (a number of times of scanning performed by the document reading section 5) at which this contamination is detected. The control section 100 causes the image forming apparatus 1 to operate in this set mode.

Upon receiving, by the operation reception section 101, selection of the selection button B1 on which “SET” is written, the setting section 106 sets the contamination detection mode and also sets, at 0, the count values C1 and C2 for counting the number of times (a number of times of reading) of scanning performed by the document reading section 5. The count value C1 is used for counting the number of times of reading of the document of the A4 size as the predefined size, and the count value C2 is used for counting the number of times of document reading regardless of the size of the document. Moreover, the setting section 106 sets a numerical value (for example, 50 times) received by the operation reception section 101 and inputted in an input box L1 at a number of times N1 to be used as a contamination detection trigger.

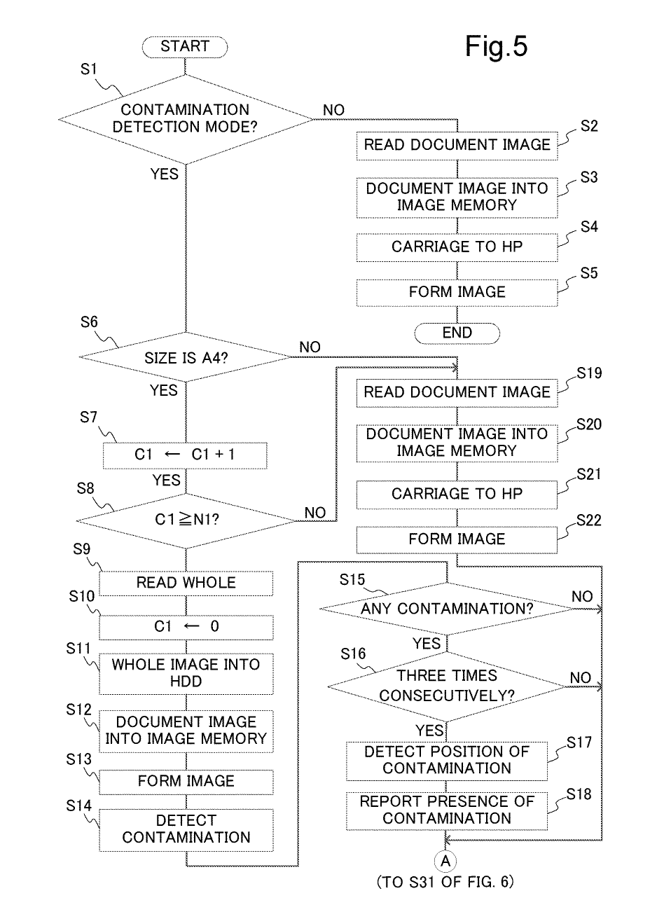

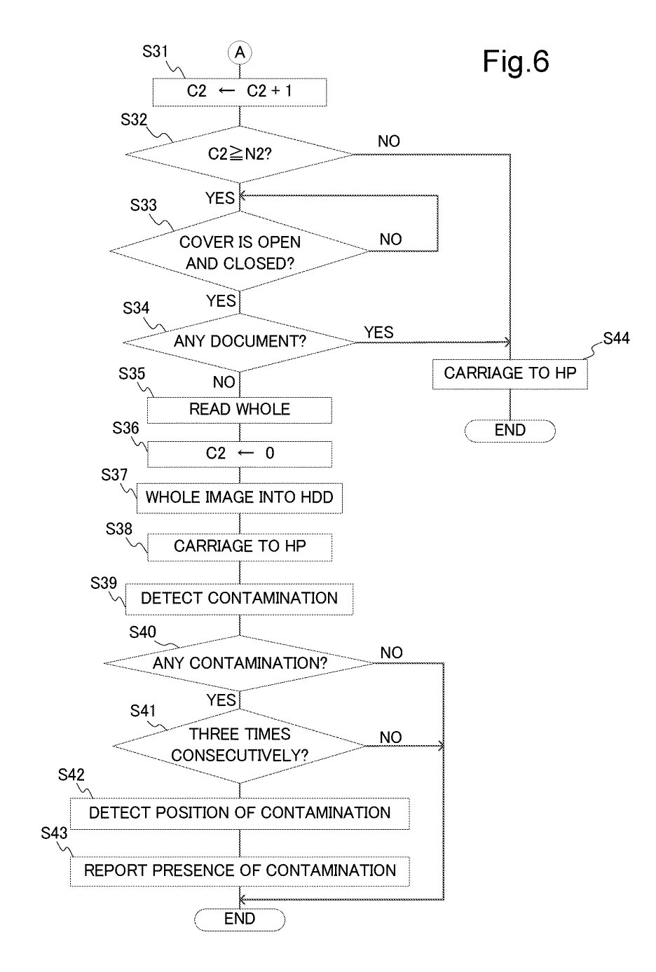

Next, one example of processing operation performed at the control unit 10 will be described based on flowcharts illustrated in FIGS. 5 and 6. Note that this processing operation is performed when, after reception of a copy instruction from the user by the operation reception section 101, the control section 100 has determined, based on the detection signal provided from the first document sensor 16, that no document is set at the document feed section 6.

First, the reading control section 102 determines whether or not the contamination detection mode has been set by the setting section 106 (S1). Upon determination by the reading control section 102 that the contamination detection mode has not been set by the setting section 106 (NO in S1), the reading control section 102 controls driving of the carriage 34 in a conventional manner in accordance with the size of the document, loaded on the document-loaded reading contact glass 162, which size is required based on a detection signal provided from the second document sensor 17, causes the document reading section 5 to read the document image (S2), causes the image memory 32 to store image data of a document region obtained through the reading by the document reading section 5 (S3), and moves the carriage 34 to a home position HP (FIG. 3) as a predefined standby position (S4), and the image formation section 12 performs image formation on the recording medium based on the image data of the document stored in the image memory 32 (S5).

On the other hand, upon determination by the reading control section 102 that the contamination detection mode has been set by the setting section 106 (YES in S1), the reading control section 102 determines based on the detection signal provided from the second document sensor 17 whether or not the size of the document loaded on the document-loaded reading contact glass 162 is an A4 size (S6). More precisely, the reading control section 102 determines whether or not the document is an A4 size and loaded longitudinally.

Upon determination by the reading control section 102 that the size of the document loaded on the document-loaded reading contact glass 162 is an A4 size (YES in S6), the reading control section 102 adds 1 to the count value C1 (S7), and determines whether or not the count value C1 is equal to or greater than the number of times N1 (for example, 50 times) (S8).

Upon determination by the reading control section 102 that the count value C1 is equal to or greater than the number of times N1 (that is, a number of times of reading of the A4-sized document has reached 50 times) (YES in S8), the reading control section 102 controls the driving of the carriage 34, causes the document reading section 5 to read not only a region of the document (A4 region here) but also the whole document-loaded reading contact glass 162 (S9), and resets the count value C1 at 0 (S10).

Subsequently, the reading control section 102 stores, into the HDD 92, the image data of the whole document-loaded reading contact glass 162 which has been obtained through the reading by the document reading section 5 (S11) and also causes the image memory 32 to store the image data of the document image obtained through the reading by the document reading section 5 (S12), and the image formation section 12 performs image formation on the recording medium based on the image data of the document stored in the image memory 32 (S13).

Then the first contamination detection section 103 detects, from latest image data of the document-loaded reading contact glass 162 which has been stored in the HDD 92 and which has been obtained through the reading by the document reading section 5, an image (that is, contamination) present in the region other than the region loaded with the document (S14). The first contamination detection section 103 determines whether or not an image (contamination) is present in any region other than the region loaded with the document (S15). Any region other than the region loaded with the A4-sized document should originally be white. In other words, when color data (image) of a color other than white in addition to the region loaded with the A4-sized document has been detected, it can be assumed that contamination is present on the document-loaded reading contact glass 162.

Upon determination by the first contamination detection section 103 that the image (contamination) is present in any region other than the region loaded with the document (YES in S15), the first contamination detection section 103 performs matching between the pieces of image data of the whole document-loaded reading contact glass 162 which data has been obtained a predefined consecutive plural number of times M1 (the consecutive three times in the past including this time, the last time, and the second last time) and which has been stored in the HDD 92, and determines whether or not the same contamination could be detected from all these pieces of image data (S16). As described above, the first contamination detection section 103 detects the same contamination by performing the matching between the pieces of image data obtained the aforementioned plural number of times M1, thus permitting accurate detection of this same contamination.

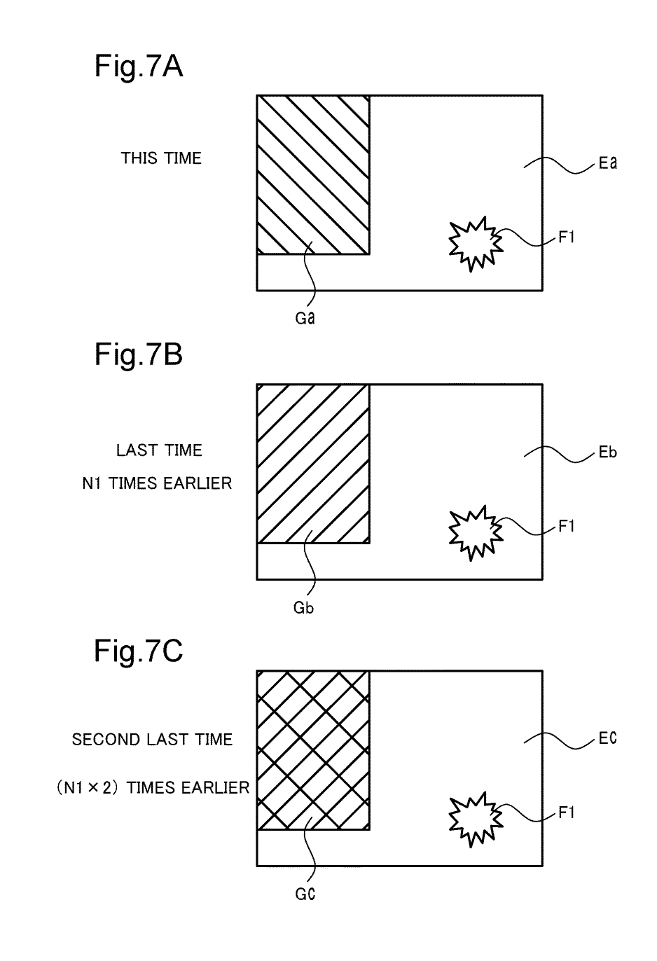

FIGS. 7A to 7C are diagrams schematically illustrating examples of the images indicated by the pieces of image data obtained consecutively three times in the past, where FIG. 7A is the image indicated by the latest image data, FIG. 7B is the image indicated by the last image data, and FIG. 7C is the image indicated by the second last image data, respectively illustrating cases where the same contamination F1 is present in regions Ea to Ec other than regions loaded with A4-sized documents Ga to Gc.

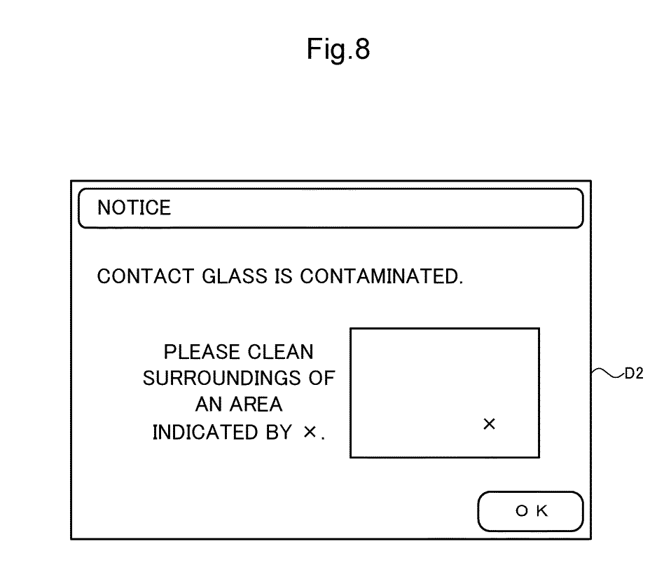

Upon determination by the first contamination detection section 103 that the same contamination could be detected from all the pieces of image data obtained consecutively three times in the past (YES in S16), the first contamination detection section 103 detects a position of this contamination on the document-loaded reading contact glass 162 (S17), the report section 105 displays a display screen D2 as illustrated in FIG. 8 at the display section 473, thereby presenting the user that the document-loaded reading contact glass 162 has this contamination and further information indicating the position of this contamination (S18), and then the processing proceeds to S31 illustrated in FIG. 6, in which processing for detecting the contamination of the document-loaded reading contact glass 162 including the region loaded with the A4-sized document is performed.

On the other hand, when the first contamination detection section 103 has determined that no image (contamination) is present in any region other the region loaded with the documents (NO in S15), or when the first contamination detection section 103 has determined that the same contamination cannot be detected from all the pieces of image data obtained consecutively three times in the past (NO in S16), there is no need of reporting the presence of contamination, and thus the processing proceeds directly to S31 (FIG. 6), skipping S17 and S18.

Moreover, upon determination by the reading control section 102 that the size of the document loaded on the document-loaded reading contact glass 162 is not an A4 size (NO in S6), or upon determination by the reading control section 102 that the count value C1 is not equal to or greater than the number of times N1 (that is, the number of times of reading the A4-sized document has not reached 50 times) (NO in S8), the reading control section 102 controls the driving of the carriage 34 in a conventional manner in accordance with the size of the document loaded on the document-loaded reading contact glass 162, which size is required based on the detection signal provided from the second document sensor 17, and causes the document reading section 5 to read the document image (S19), causes the image memory 32 to store the image data of the document region obtained through the reading by the document reading section 5 (S20), and moves the carriage 34 to the home position HP (S21), and the image formation section 12 performs image formation on the recording medium based on the image data of the document stored in the image memory 32 (S22), and then the processing proceeds to S31 (FIG. 6).

In S31 illustrated in FIG. 6, the reading control section 102 adds 1 to the count value C2 (S31), and determines whether or not the count value C2 is equal to or greater than a predefined number of times N2 (S32). The number of times N2 is set at a number of times greater than the number of times N1, for example, set at approximately 200 times.

Upon determination by the reading control section 102 that the count value C2 is equal to or greater than the number of times N2 (that is, the number of times of the document reading has reached 200 times) (YES in S32), the reading control section 102 determines based on the detection signal provided from the open-close sensor 15 whether or not the document feed section 6 functioning as the document press cover of the document-loaded reading contact glass 162 has been opened and closed (S33).

Upon determination by the reading control section 102 that the document feed section 6 has been opened and closed (YES in S33), the reading control section 102 determines based on the detection signal provided from the second document sensor 17 whether or not the document is loaded on the document-loaded reading contact glass 162 (S34).

Upon determination by the reading control section 102 that no document is loaded on the document-loaded reading contact glass 162 (NO in S34), the reading control section 102 controls the driving of the carriage 34 and causes the document reading section 5 to read the whole document-loaded reading contact glass 162 loaded with no document (S35), resets the count value C2 at 0 (S36), the reading control section 102 causes the HDD 92 to store all the pieces of image data of the whole document-loaded reading contact glass 162 obtained through the reading by the document reading section 5 (S37), and moves the carriage 34 to the home position HP (S38).

Subsequently, the second contamination detection section 104 detects, from among the latest image data of the whole document-loaded reading contact glass 162 loaded with no document which image data has been stored in the HDD 92 and which has been obtained through the reading by the document reading section 5, any image (contamination) present on the document-loaded reading contact glass 162 (S39), and the second contamination detection section 104 determines whether or not any image (contamination) is present on the document-loaded reading contact glass 162 (S40).

Upon determination by the second contamination detection section 104 that any image (contamination) is present on the document-loaded reading contact glass 162 (YES in S40), the second contamination detection section 104 performs matching between the pieces of image data of the whole document-loaded reading contact glass 162 loaded with no document which image data has been obtained consecutively the predefined plural number of times M2 and which has been stored in the HDD 92 (three consecutive times in the past including this time, the last time, and the second last time here), and determines whether or not the same contamination could be detected from all these pieces of image data (S41). As described above, the second contamination detection section 104 detects the same contamination by performing the matching between the pieces of image data obtained the aforementioned plural number of times M2, thus permitting accurate detection of the same contamination.

Upon determination by the second contamination detection section 104 that the same contamination could be detected from all the pieces of image data obtained consecutively three times in the past (YES in S41), the second contamination detection section 104 detects a position of this contamination on the document-loaded reading contact glass 162 (S42), and the report section 105 presents, via the display section 473, the user that this contamination is present on the document-loaded reading contact glass 162 and further the information indicating the position of this contamination (S43).

On the other hand, upon determination by the second contamination detection section 104 that no image (contamination) is present on the document-loaded reading contact glass 162 (NO in S40), or upon determination by the second contamination detection section 104 that the same contamination cannot be detected from all the pieces of image data obtained consecutively three times in the past (NO in S41), there is no need of reporting the presence of the contamination, and thus this processing operation directly ends.

Moreover, upon determination by the reading control section 102 that the count value C2 is not equal to or greater than the number of times N2 (that is, the number of times of the document reading has not reached 200 times) (NO in S32) or upon determination by the reading control section 102 that any document is loaded on the document-loaded reading contact glass 162 (YES in S34), there is no need of reading the whole document-loaded reading contact glass 162 for the contamination detection, and thus the reading control section 102 moves the carriage 34 to the home position HP (S44), and this processing operation ends.

Here, in typical image reading devices, document-loaded reading contact glass is frequently touched by a human's hand, and may be contaminated by stain in addition to dust and a foreign substance. Some of the typical image reading devices are known to detect contamination of document-conveyed reading contact glass. Moreover, some typical image reading devices have been suggested which detect contamination of the document-loaded reading contact glass, and upon determining presence or absence of any document on the document-loaded reading contact glass and determining that any document is absent, the image reading device detects contamination of the document-loaded reading contact glass and displays results of the detection. That is, when any document is absent, it is required to perform special processing only for contamination detection, for example, driving a scanner, which raises a problem of deteriorated productivity.

On the contrary, according to the first embodiment described above, to cause the document reading section 5 to read the document loaded on the document-loaded reading contact glass 162, the document reading section 5 is caused to read the whole document-loaded reading contact glass 162 at a rate of once per the predefined number of times N1 (for example, a rate of once per 50 times), and the contamination of the document-loaded reading contact glass 162 present in the region other than the region loaded with the document is detected from the image data of the whole document-loaded reading contact glass 162 obtained through the reading by the document reading section 5. That is, the document reading section 5 is not driven only for the contamination detection, thus permitting prevention of the productivity deterioration.

Moreover, upon detecting the same contamination from all the pieces of image data obtained consecutively the predefined plural number of times M1 (for example, three times), the user is notified that this contamination is present on the document-loaded reading contact glass 162. For example, when the same contamination has been detected consecutively three times, the user is notified of the presence of this contamination. Consequently, this can prevent erroneous notification of the presence of the contamination to the user although no contamination is actually present.

Further, according to the first embodiment described above, not only when any document is loaded, but also when no document is loaded, the image data of the whole document-loaded reading contact glass 162 is regularly read to detect the contamination of the document-loaded reading contact glass 162 from this image data, which therefore permits detection of not only the contamination located outside of the region loaded with the document but also contamination located in the region loaded with the document.

Reading of this image data when no document is loaded is special processing only for the contamination detection, leading to a risk of deteriorated productivity, but since a frequency of this reading is relatively small, for example, approximately once per 200 times, the productivity deterioration can be suppressed.

Moreover, the reading control section 102 causes the document reading section 5 to read the document loaded on the document-loaded reading contact glass 162 and then moves the carriage 34 to the home position HP in normal occasions (S4 and S21 of FIG. 5), but to cause the document reading section 5 to read the whole document-loaded reading contact glass 162 when no document is loaded, the carriage 34 is not immediately moved to the home position HP, the document reading section 5 is first caused to read the whole document-loaded reading contact glass 162 loaded with no document, and then the carriage 34 is moved to the home position HP (S38 of FIG. 6). Consequently, this can efficiently move the carriage 34, suppressing the productivity deterioration.

This disclosure is not limited to the configuration of the embodiment described above, and thus various modifications can be made. Moreover, the embodiment has been described above, referring to the multifunction peripheral of the image forming apparatus as one embodiment of the image reading device according to this disclosure, but this is just one example, and another electronic device, such as an image reading device having a copy function, a printer function, a scanner function, and a facsimile function may be used.

Moreover, the configuration and the processing indicated in the embodiment described above referring to FIGS. 1 through 8 are just one embodiment of this disclosure, and this disclosure is not limited in any way to these configuration and processing.

Various modifications and alterations of this disclosure will be apparent to those skilled in the art without departing from the scope and spirit of this disclosure, and it should be understood that this disclosure is not limited to the illustrative embodiments set forth herein.

What is claimed is:

1. An image reading device comprising:
contact glass for loading a document thereon;
a document reading section having a moving mechanism capable of reciprocally moving in a predefined document reading direction, the document reading section reading the document loaded on the contact glass while the moving mechanism moves in the document reading direction;
a reading control section, to cause the document reading section to read the document loaded on the contact glass, causing the document reading section to read the whole contact glass at a rate of once per a predefined number of times N1;
a first contamination detection section detecting, from image data of the whole contact glass obtained through the reading by the document reading section, contamination of the contact glass present in a region other than a region loaded with the document; and
a report section, upon detecting by the first contamination detection section the same contamination from all the pieces of image data obtained consecutively a predefined plural number of times M1, reporting a user that the contamination is present on the contact glass.

2. The image reading device according to claim 1, further comprising
a display section displaying various pieces of information, wherein
the first contamination detection section detects the contamination of the contact glass and also detects a position of the contamination on the contact glass, and
the report section causes the display section to display the information indicating the position of the contamination detected by the first contamination detection section.

3. The image reading device according to claim 1, wherein
to cause the document reading section to read a document of a predefined size loaded on the contact glass, the reading control section causes the document reading section to read the whole contact glass at a rate of once every time the document of the predefined size is read the predefined number of times N1.

4. The image reading device according to claim 3, wherein
the predefined size is set at an A4 size.

5. The image reading device according to claim 1, wherein
the first contamination detection section detects the same contamination through matching performed between the pieces of image data obtained a plural number of times M1.

6. The image reading device according to claim 1, wherein
the reading control section causes the document reading section to read the document loaded on the contact glass and then causes the document reading section to read the whole contact glass loaded with no document at a rate of once per a predefined number of times N2 (greater than the predefined number of times N1), the image reading device further comprising
a second contamination detection section detecting, from the image data of the whole contact glass loaded with no document, which data has been obtained through the reading by the document reading section, contamination of the contact glass, wherein
when the second contamination detection section has detected the same contamination from all the pieces of image data obtained consecutively a predefined consecutive plural number of times M2, the report section reports to the user that the contamination is present on the contact glass.

7. The image reading device according to claim 6, wherein
the reading control section causes the document reading section to read the document loaded on the contact glass and then moves the moving mechanism to a predefined standby position in a normal occasion, and
to cause the document reading section to read the whole contact glass loaded with no document, without moving the moving mechanism to the standby position, the document reading section is caused to read the whole contact glass loaded with no document and then the moving mechanism is moved to the standby position.

8. The image reading device according to claim 6, wherein
the second contamination detection section detects the same contamination through matching performed between the pieces of image data obtained the plural number of times M2.

9. The image reading device according to claim 1, further comprising:
an operation reception section receiving an operation input from the user; and
a setting section, upon receiving, by the operation reception section, a request from the user for setting a contamination detection mode in which the contamination of the contact glass is detected, setting the contamination detection mode, wherein
when the contamination detection mode is set by the setting section, the reading control section causes the document reading section to read the whole contact glass to detect the contamination of the contact glass.

10. An image forming apparatus comprising:
the image reading device according to claim 1, and
an image formation section performing image formation on a recording medium based on the image data of the document obtained through the reading by the image reading device.
